(19) United States
(12) Patent Application Publication
(10) Pub. No.: US 2021/0114235 A1
(43) Pub. Date: Apr. 22, 2021

(54) MODULAR SYSTEM FOR CONSTRUCTING ROBOTS

(71) Applicant: Kugar Inc., San Francisco, CA (US)

(72) Inventor: Gary Stanley Kurek, San Francisco, CA (US)

(21) Appl. No.: 17/085,647

(22) Filed: Oct. 30, 2020

Related U.S. Application Data
(63) Continuation of application No. 15/842,518, filed on Dec. 14, 2017, now abandoned.
Application No. 15/842,518 is a continuation-in-part of application No. 14/815,687, filed on Jul. 31, 2015, now abandoned.
(60) Provisional application No. 62/032,262, filed on Aug. 1, 2014.

(51) Int. Cl. B25J 17/00; B25J 19/00; B25J 19/02; B25J 18/00; B25J 9/08

(52) U.S. Cl. CPC B25J 17/00; B25J 19/0075; B25J 9/08; B25J 18/00; B25J 19/02

(57) ABSTRACT

A robotics system is built from four components: a joint assembly, links, universal connectors, and end caps. These components may be arranged and configured in a number of different ways to create a wide array of popular robots that are useful for different purposes. Sensor suits maybe built into a robot's rotating joints, enabling sensor suits in every axis if so desired.

### CROSS-REFERENCE TO RELATED APPLICATIONS

This Application is a Continuation Application of U.S. patent application Ser. No. 15/842,518, filed on 14 Dec. 2017, which is a Continuation-In-Part of U.S. patent application Ser. No. 14/815,687, filed on 31 Jul. 2015, entitled “MODULAR SYSTEM FOR CONSTRUCTING ROBOTS”, which claims the benefit of U.S. Provisional Application No. 62/032,262 filed on 1 Aug. 2014, all of which are incorporated in their entireties by this reference.

### TECHNICAL FIELD

This invention relates generally to the field of robotics, and more specifically to a new and useful modular system for constructing robots.

### BACKGROUND

In conventional robotics solutions, most robots are either single-purpose robots custom-tailored to a specific use or multipurpose models. A multipurpose robotic configuration invariably contains unneeded features and parts to allow it to accomplish a wide range of tasks, which a single-purpose robot configuration may be well-suited for a particular task, certain elements of the robot may be useless for another task or render the robot itself unable to perform the different task. In the single-use robotic scenario, a user may have to purchase multiple custom robotic solutions in order to perform multiple tasks, adding additional expense due to small differences making the machines unusable for different purposes. In the multipurpose robot solution, the user again faces a lack of efficiency, having a robot with additional parts that are unneeded and contribute to additional up-front costs as well as additional maintenance.

In many cases visual sensors and cameras for scanning the surrounding environment are often mounted in two possible places. One place is external from the robot structure, as a sensor next to the robot, on top of the robot, or on the robot's end effecter The sensors may be static (fixed in place/orientation), or they may pan and tilt, but they usually stay in one spot and are intended to have a field of view of most or all of the robot's entire workspace. This method has limitations. By being mounted in one place, and at varying distance from the areas the robot is carrying out its work, inconsistent accuracy and performance are a result. In an effort to put sensors in constant closer view of a robot's work areas, some have opted to put cameras and sensors into the robot's end effecter. The end effecter is the gripper/tool that the robot uses to grasp objects/interact with its physical environment. Putting sensors into custom end effecter tools isn't scalable (thus is expensive), and often leads to obstructed fields of view when the robots grasps objects. Additionally, hooking up these external sensors requires numerous wires and custom components, which may compromise a robot's performance.

### BRIEF DESCRIPTION OF THE FIGURES

FIG. 1 is an embodiment of a modular system for constructing robots 100.

FIG. 2 illustrates an embodiment of a joint assembly 200.

FIG. 3 illustrates an embodiment of a joint assembly 300.

FIG. 4 illustrates an embodiment of link assembly and end cap 400.

FIG. 5 is an embodiment of a universal connector 500.

FIG. 6 is an embodiment of a six-axis configuration modular system for constructing robots 600.

FIG. 7 is an embodiment of a seven axis redundant robot 700.

FIG. 8 illustrates an embodiment of a six-axis robot and SCARA robot 800.

FIG. 9 illustrates a variety of exemplary linkage configurations.

FIG. 10 is a schematic representation of an end cap with lights.

FIG. 11 illustrates a variety of exemplary universal connectors.

FIG. 12 is a schematic representation of a universal connector.

FIG. 13 illustrates a sensor module.

FIG. 14A, FIG. 14B, and FIG. 14C are schematic representations of delta robot configurations.

FIG. 15 is a schematic representation of a multi-arm robot configuration.

FIG. 16 is a schematic representation of a Cartesian plane robot configuration.

FIG. 17 is a flowchart representation of a method of a constructing a set of modular robot components.

### DESCRIPTION OF THE EMBODIMENTS

The following description of the embodiments of the invention is not intended to limit the invention to these embodiments but rather to enable a person skilled in the art to make and use this invention.

### 1. Glossary

“End cap” in this context refers to a cap that connects to a universal connector, which may be already connected to another component. It provides another means of attaching equipment, protects the connector, and allows for the attachment of additional exterior sensors and equipment. The end cap shows up usually at the end of the assembly and serves both aesthetic and functional purposes. Its rounded shape makes it safer to use around people, minimizing the number of sharp edges. It keeps dust, dirt, and other harmful particles out of vulnerable areas. The end cap can be easily modified to include certain things like lights, or buttons, etc. that might serve useful in a range of applications. It is also a core industrial design element of the whole platform, allowing for a very distinctive look.

“Joint assembly” in this context refers to a module generally composed at least one of the following parts a motor for motion, a gear reducer (transmission) to increase the torque, and/or various sensors that may be application specific. In addition, the joint assembly connects with adjacent pieces via universal connectors. The joint itself can be changed so that it can take many different forms. Some embodiments will be just a motor or a sensor, some might simply be a motor, and others might have a transmission, while other embodiments will have all three. Furthermore, the modularity of a joint assembly can enable different classes of motors, sensors, and/or transmissions to be selectively employed for different use cases. For example, a high-end motor may be used when high precision is needed while a low-end motor may be used when the use case has a high tolerance for imprecision. Similarly, the sensing capabilities can be customized for a use case and altered depending on the situation.

“Motor unit housing” in this context refers to a container for housing a motor. It is implied that the motor unit housing contains a motor.

“Sensor module” in this context refers to a sensor module is a component which may contain sensors such as transducers, cameras, vibration sensors, scanners lidar, etc.

“Transmission” in this context refers to a transmission module that may be a gear reducer to take motor input and change the torque to the output.

“Link assembly” in this context refers to a component that provides structural support to components on either side and allows for the internal routing of power and communication lines. The link assembly can be a special class of module assembly that lacks an internal active component such as a motor, transmission, sensors, or other components. The link assembly may act as a structural element providing spacing or form to a linkage. In one embodiment it may take the form of a hollow cylinder with cables routed through the interior and power and communication connections on the ends. Herein, linear spacing link assemblies are described as the primary example of a link assembly, providing linear spacing between two opposite engagement regions. However, a link assembly can alternatively be nonlinear (e.g., curved) and/or have any suitable number of engagement regions such as in the universal connector.

“Universal connector” in this context refers to a component which couples multiple other components or modules together. A universal connector fits together with all other main components and may connect any of them together, including, but not limited to, transmission modules, motor unit housings, link assemblies and sensor modules. A universal connector may be a simple sleeve ring to connect two components linearly, or may have multiple sleeve rings connected by a bracket to allow two units to connect at an angle. A basic universal connector can couple linearly adjacent modules (e.g., a motor unit housing and transmission module). An angled universal connector can enable angled coupling between two or more components.

### 2. System

A modular system for constructing robots described herein allows for customized robot designs that can offer flexibility in the mechanical, kinematic, and/or sensing capabilities. The modular system can make use of sensors and scanning technologies, including but not limited to cameras, infrared sensors, sonar sensors, lights, and lidar to be used in multiple places on a constructed robot, including but not limited to the joints (the points of rotation), the linkages, and all pieces that attach the joints together. This versatility allows aforementioned scanning technology to be used in ways that no other robotics solution allows. The invention relates to robotic systems, and more particularly, to data analytics and processing of data collected by vision and scanning technology including but not limited to cameras, infrared sensors, sonar sensors, lights, and lidar. The modular system can make use of various actuating and driver technologies including but not limited to motors, transmissions, encoders, end effectors (e.g., robotic manipulator, machine tool, etc.), and/or other active elements. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiments shown but is to be accorded the widest scope consistent with the principles and features described herein.

The modular nature of this system allows for the creation of a robotics (or even broader, mechatronic or motion) platform that allows for the integration of a range of different parts or pieces based on what's needed by the user, limiting the wasting of time and resources due to the inclusion of unnecessary parts and functions.

The modular nature of the system allows a user to use the type of motor they need, couple it with the correct type of transmission and sensors (optical or otherwise) acquiring only the parts needed for their given application. In addition, the user can make changes and upgrades on an ongoing basis, changing and combining components of this modular system on the fly. For example, a user may initially build a robotic configuration from the modular system using a basic motor system. When the performance requirements change or the stage of the project necessitates better performance, the robotic configuration can be easily upgraded by swapping in a high-performance motor system. The modularity of this system also opens up options for easily integrating different types of sensors in new ways, which allows for new ways to collect data.

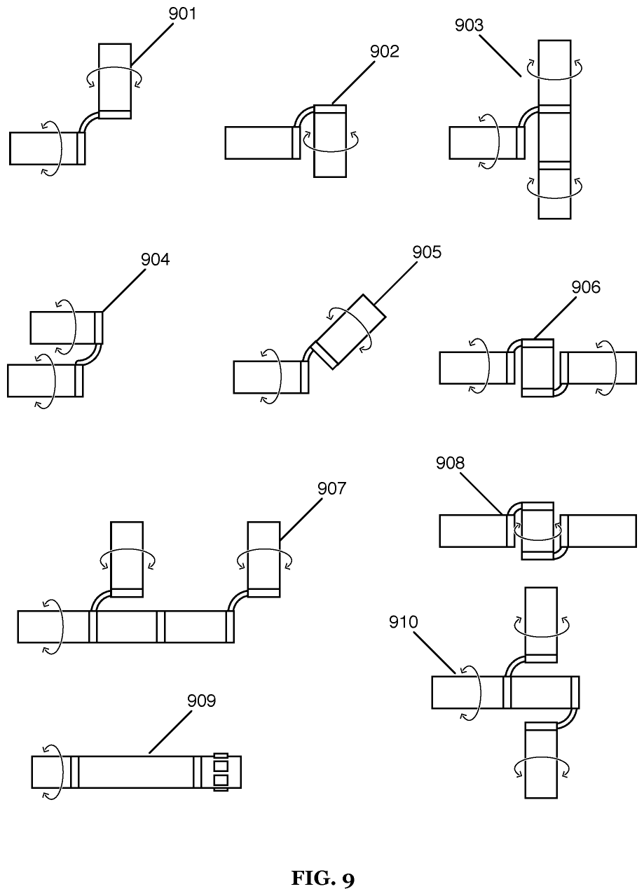

The modular robotics system described herein can be comprised of four main component types. These four components are each a sub-assembly and may be arranged and configured in a number of different ways to create a wide array of robot configurations, which may be used to build popular types of robots or custom robot configurations that are useful for different purposes. The components can be combined and customized to form a wide variety of robotic linkages as shown in FIG. 9. Basic right angle alignment could be achieved as shown in linkages 901 and 902. Alternative angular and translational arrangement may be achieved as shown in linkages 904 and 905. More complex linkages can be used to establish different configurations as shown in linkages 906, 907, 908, and 910. Furthermore, basic linkages connecting components in a line can be achieved as shown in linkage 909 with a motor housing unit with a sensor module at an opposite end. The robotic linkages when combined can be used to form a greater variety of robotic configurations, which may be used to build robotic configurations such as six-axis robots, SCARA robots, delta robots, multi-arm robots, Cartesian plane robots, and/or any suitable robot system. This enables a system that is flexible yet specific in the machines it may construct. Sensor suits may be built into a robot's rotating joints, enabling sensor suits in every axis if so desired. Panning, tilting, mounting, and adjustment of a sensor's field of view is highly customizable from a small set of core components. The sensors thus may better perceive their environments, leading to more consistent robotic performance. Additionally, all power and data lines in the robotic system are integrated. There are no extra wires or cables to worry about when hooking up sensor suites to the described robotic system. Instead of two options of mounting sensors, there are virtually endless configuration possibilities.

The four primary components of the modular system can include:

1. Joint assembly

2. Link assembly

3. Universal connector

4. End caps

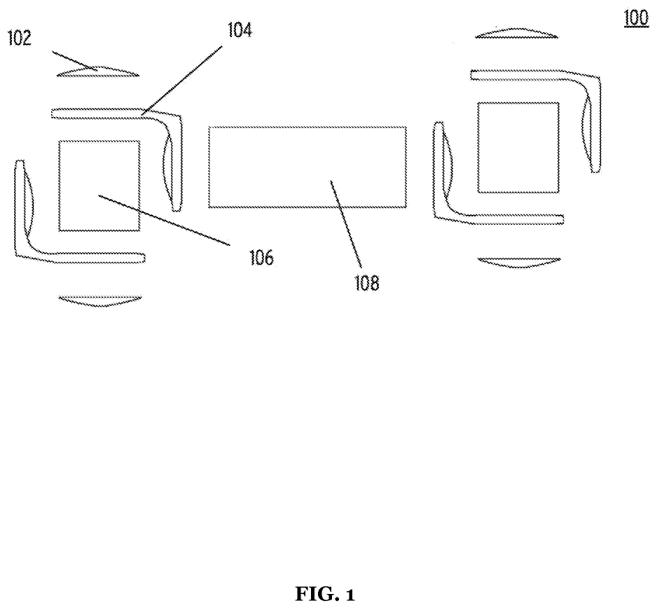

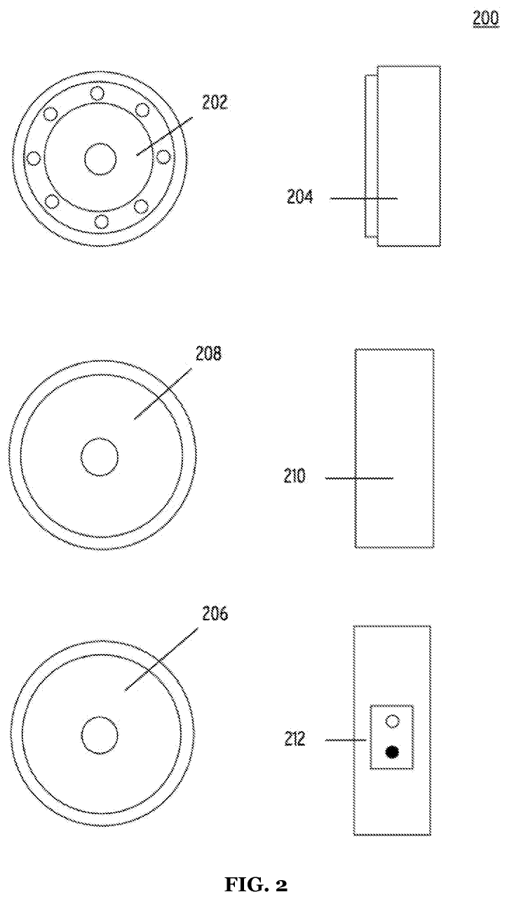

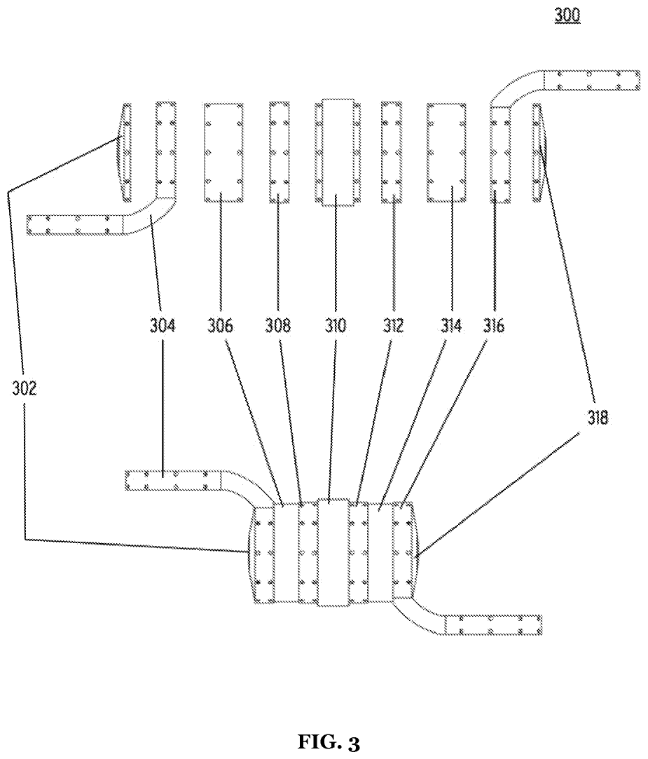

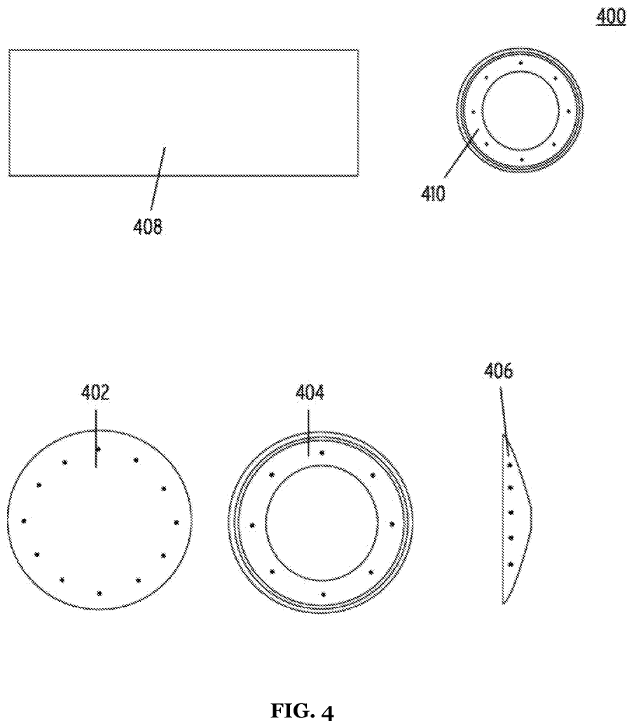

Exemplary embodiments of these four components are illustrated in FIG. 1. FIG. 2 illustrates the three separate components that may be most commonly employed in a typical joint assembly (with both front and side views). Most commonly, an actuator will require a motor for motion, a gear reducer (transmission) to increase the torque, and various sensors that may be application specific. Other items that could be included but aren't drawn above could be encoders to read positions, or spacers that are used mostly as structures to allow the actuator to work with the rest of the modular system for constructing robots. All of these joint pieces will typically be of a cylindrical disk or puck shape, but don't have to be. Alternative profiles of the joint and/or link assembly components can include rectangles, pentagon, hexagon, and/or other suitable profiles may be used. The reason to separate these parts is that different applications will have different requirements when it comes to things like speed, payload, and precision for example. Customers often have to buy robots or actuators with predefined feature sets, whether they need the features or not. This adds to cost, complexity, and wastefulness. By separating the core pieces of the actuator, a wide range of different robots and motion platforms can be created. FIG. 3 illustrates an exploded view of a joint assembly. FIG. 4 illustrates a front view of a joint assembly. The joint assembly can house a motor unit housing, transmission module, sensor module, and/or electronics. The joint assembly enables motion/rotation at each of the robot's axis points. The joint is a round cylindrical unit in one embodiment, with a motor unit housing containing a motor allowing this unit to be a point of rotation. The point of rotation is where an output shaft of the actuator is attached to a flange (engagement region or in other words surface for mounting another component) that can be connected to other components of the robot.

In addition to allowing for a sensor unit to be integrated into the joint assembly itself, the end of the joint assembly has a joint engagement region that may be attached to the other components of the robotic system (preferably through a universal connector). These joint engagement regions have connection points for the power and data lines that run through the entire robotic system, as well as mounting points that allow the joint to be bolted securely to the other components of the robot. Complementary connection points can be included in join assembly components, link assembly components, and universal connectors, such that by physically connecting the components the power and data lines are also connected. Additionally, component identification circuitry can be included such that a controller could determine the type of connected components and possibly the configuration of the various components. In some cases conductive brushes can be used to maintain conductive contact between components that rotate or move.

Optionally, additional sensors may be mounted to the side of joint. This is particularly useful for sensors and transducers such as cameras and scanners useful for vision and perception. Because these sensor suites can be attached to the points of rotation, the field of views, angles, and positions of the sensors may be manipulated in unique ways. This flexibility allows for new and enhanced techniques to perceive objects and carry out tasks efficiently and intelligently.

Most commonly, a joint assembly can include a motor for motion, a gear reducer (transmission) to convert the torque and/or speed, and various sensors that may be application specific. Other items that could be included but aren't drawn above could be encoders to read positions, or spacers that are used mostly as structures to allow the actuator to work with the rest of the modular system for constructing robots. All of these joint pieces will typically be of a cylindrical disk or puck shape, but don't have to be. The reason to separate these parts is that different applications will have different requirements when it comes to things like speed, payload, and precision for example. Customers often have to buy robots or actuators with predefined feature sets, whether they need the features or not. This adds to cost, complexity, and wastefulness. By separating the core pieces of the actuator, a wide range of different robots and motion platforms can be created. The various components preferably utilize a common mounting approach so that the various components can be arranged interchangeably. Universal connectors are preferably used as a common coupling mechanism to connect two or more components. Different types of universal connectors may offer different coupling configurations such as coaxial, adjacent coupling or angled coupling.

FIG. 4 illustrates front and side views of an embodiment of a link assembly component (top), and various views of an embodiment of end caps (bottom). In one embodiment, the link is a variable length piece comprising integrated power and data lines (allowing the whole robot to be assembled without excess hanging wires) that may be attached between one joint (or set of joints) and another. If a joint is utilized as an elbow or wrist of an arm, and the connectors represent tendons, then the link is the straight bone that connects the joint and connectors. The link assembly component can function to statically define the linkage length within a given robotic linkage subsystem. In one embodiment, the link assembly may be implemented as a straight piece of cylindrical tube (same diameter of the joint assemblies) that is mostly a structural support. The link assemblies are preferably straight components but various link assemblies (including customized non-linear link assemblies) maybe compatible with the modular system. Additionally, the link assembly bridges the power and data communication lines between various components. The link may be attached to the connectors, joints, or end caps, allowing it to be versatile and serve a number of different uses.

The end caps can potentially serve at least three purposes. They may function as aesthetic covers that create a clean design, they maintain the engagement regions of other components covered and sealed, and an optional lighting system may be built in to the end cap to provide a visual aid to programming the robot as well as helping with diagnostic tests and providing visual cues for faulty parts or safety warnings. An end cap preferably includes a connection side and an opposing sealing face. An end cap is preferably mountable to a component, such as a universal connector, on the connection side. In a cylindrical component approach, the end cap is cylindrical with a shallow profile (i.e., the height of the cylinder is less than the diameter), though a deep profile may alternatively be used. The cylindrical end cap can define an internal cavity on one face of the cylinder. In a smart end cap variation discussed in the lighting variation above, the sealing face of the end cap or any suitable portion of the end cap can include user interface elements and/or sensor elements. The user interface elements can include lighting system elements such as indicator lights, screens, LCD displays, and/or any suitable visual display. Similarly, the user interface elements could include speakers. Other variations may include user input elements such as a touch screen, switches, pushbuttons, dials, and the like. A smart end cap variation may additionally enable sensors to be added at the end cap mounting positions. A smart end cap variation preferably includes an electrical interface coupling to the power and communication lines of the universal connector.

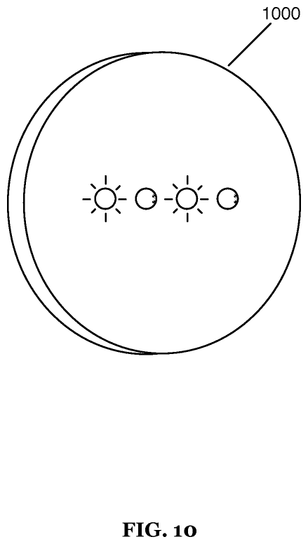

In some embodiments the end caps have built in LED lights that serve a set of unique purposes as shown in end cap 1000 in FIG. 10. Robots built from the components should be capable of being safely used around people. The lights may change or otherwise signal that an error occurred while the robot was carrying out a task. For example, lights on the end caps of each axis or link may blink bright red indicating that there was a problem. Robots built from the components may be programmed easily, by dragging the arm around and replaying the motions in a record/play type of fashion. This allows for programming without the need of experienced engineers or programmers.

The lights on end caps/links may blink in different colors and patterns to communicate different things such as when it's safe to touch the robot or when to leave it alone, etc. The lighting system may facilitate diagnostics and repairs. If an axis or piece of the robot fails, that particular axis may light up communicating that it needs to be replaced. This makes diagnostic tests faster and more seamless. In addition to the diagnostics being simpler, repairs themselves may be simpler and faster given that fixing the robot is a matter of simply replacing modules, not requiring an entire disassembly of the whole system.

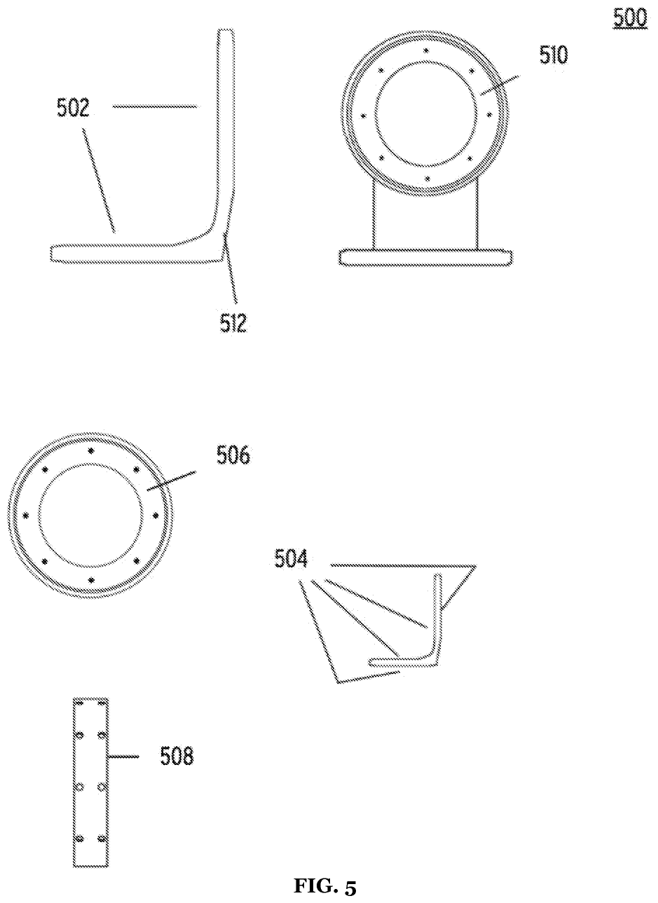

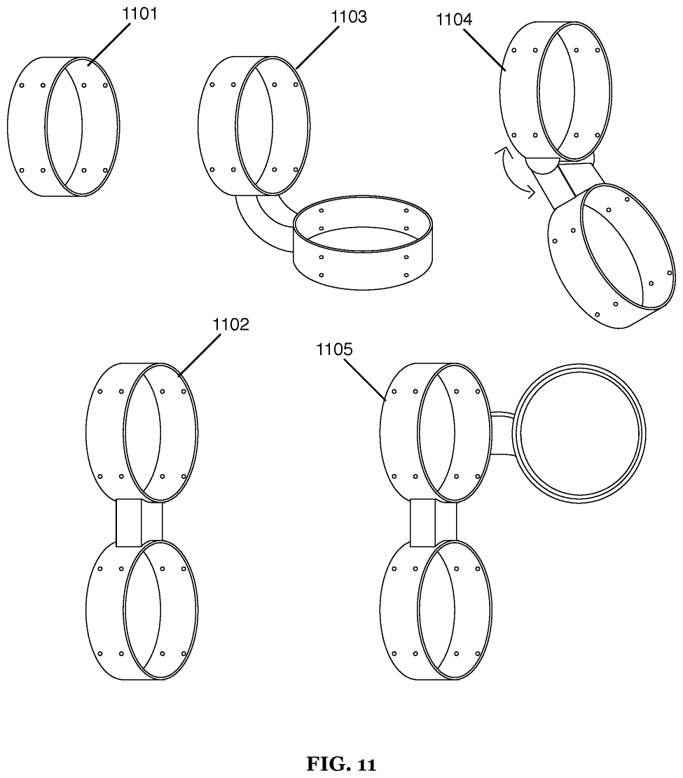

FIG. 5 is a side and front view illustration of an embodiment of a universal connector. The figure includes a connector diagram (lower part of figure) locating the engagement regions. The connecting components may be mounted to from four different directions, whereas existing modular systems typically provide only two possible connection points. In one embodiment, L-shaped universal connectors form the ‘glue’ of the robotics system, with two connector rings attached via a coupling bracket. In other embodiments shown in FIG. 11, the universal connector may consist of only a single sleeve ring 1101, two sleeve ring mounted in a side-by-side configuration 1102, two rings with a predefined angular offset 1103, multiple sleeves 1104, adjustable connector configurations 1105, or other configurations. The universal connectors are what hold the other components (joint, links, and/or end caps) together, enabling a wide range of configurations. A basic universal connector can include at least one double-sided sleeve engagement structure (i.e., a mounting structure with two distinct engagement regions) that can be used to couple adjacent components with a coaxial alignment. A sleeve engagement structure with two engagement regions may be used in a basic universal connector. An angled universal connector can comprise at least two double-sided sleeve engagement structures enabling joints, links, and end caps to attach to either side of the connectors with an angular or translational offset of the central axis of the components. A sleeve engagement structure is preferably a cylindrical ring with an engagement region on a first side of the cylindrical ring and a second engagement region on the second side of the cylindrical ring. Various attachment mechanisms may be used. In one variation, the engagement region includes a defined inset cavity to which a joint, link or end cap slides into, and the engagement region can additionally include a set of defined through holes used to screw, bolt, or otherwise fasten/fix a component in position. In another variation, a clamp or latch mechanism may be used to enable fast attachment and detachment of a component. In another variation, the engagement regions may promote snapping or screwed coupling. Any suitable fastening mechanism may alternatively be used.

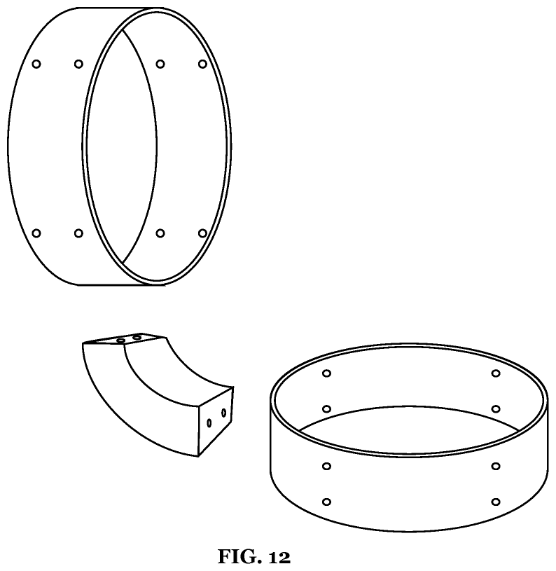

Multiple sleeves can be connected to other sleeves through a bracket. In one variation, the sleeves can be removably attached to a bracket as shown in FIG. 12. In an alternative variation, the two or more sleeves can be permanently coupled through the bracket structure. This novel dual-ended attachment freedom enables a wide range of unique configurations. Connectors also comprise integrated power and data lines. Power and data lines are automatically bridged between connected components when connected with a universal connector. The power and data lines preferably traverse through a bracket and connector rings and conductively couple to a joint, link, and/or end cap component through a suitable electrical connector. In one exemplary implementation, spring-loaded pins establish an electrical connection between engagement regions of a universal connector and another component.

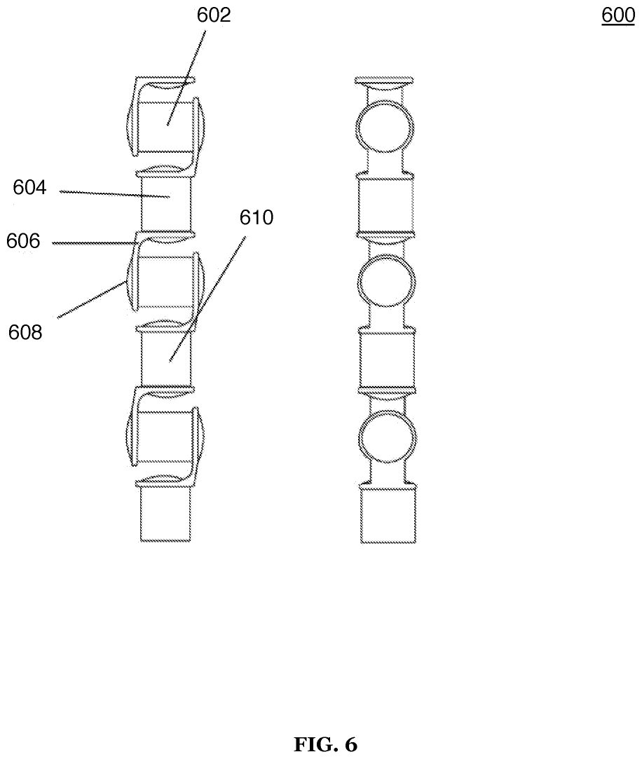

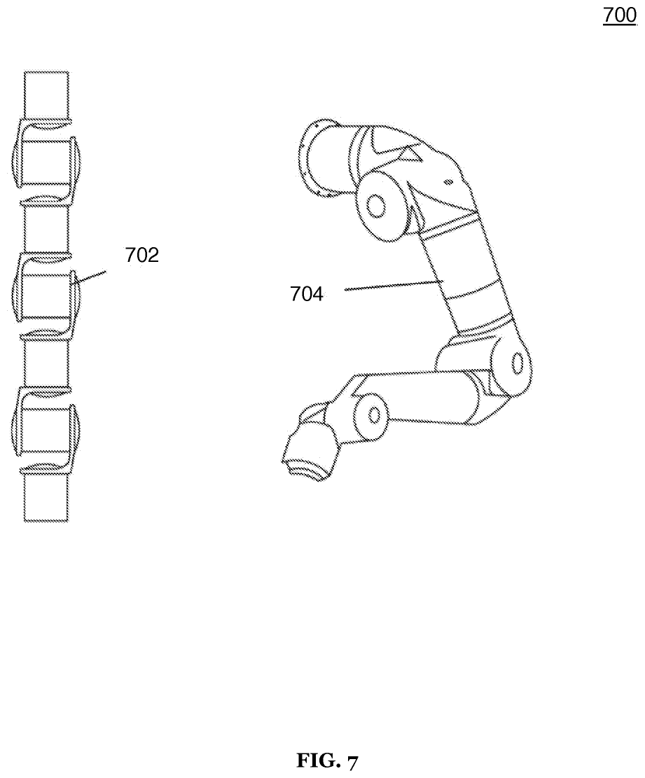

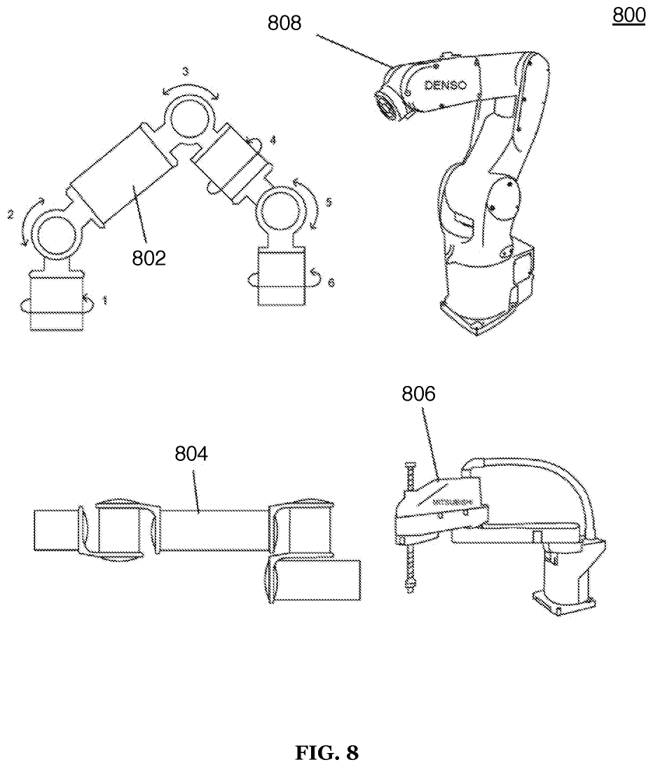

FIG. 6 is a side view (left) and front view (right) of an embodiment of a six-axis configuration. This configuration six joints, six connectors, and twelve end caps. In this configuration, the vertically mounted joints also serve the purpose of a link. FIG. 8 illustrates an embodiment of a six-axis robot and a SCARA robot that may be constructed from the components. FIG. 7 illustrates an embodiment of a seven-axis redundant robot embodiment that may be constructed from the components.

One benefit of the described modular system for constructing robots is that because of the modularity and few types of components, physical repairs of the system may be carried out by non-highly technical staff. The physical repair of any part of the system may be as easy as removing a few bolts, and replacing a module. Similarly, the construction of a new robotic configuration can be completed using easy to follow instructions with the supplied components.

FIG. 1 is an embodiment of a modular system for constructing robots 100. As described and shown in FIG. 1, the system preferably comprises a plurality of universal connectors 104, a joint assembly 106, link assembly 108, and/or a plurality of end caps 102. The system can additionally include a sensor module, a motor unit housing, and a transmission module. The elements of the system are preferably offered as a set of components that can be selectively used in combination to operate as a robotic configuration.

In one exemplary implementation of the system, the system may include a first link assembly, a second link assembly, a first universal connector and a second universal connector, a joint assembly, a first end cap, and a second end cap. The first and second universal connector can act as coupling mounts between a link assembly and the joint assembly. The first link assembly can be detachably coupled to the joint assembly via the first universal connector. The second link assembly detachably coupled to the joint assembly opposite the first link assembly via the second universal connector wherein the joint assembly engenders axial rotational motion to the second link assembly. The first end cap can be detachably coupled to the first link assembly opposite the joint assembly, and the second end cap detachably coupled to the second link assembly opposite the joint assembly.

These components of the system can be utilized to create a wide variety of linkage elements by offering customized actuation translation (e.g., by altering the geometry in how the link assemblies and joint assembly are oriented), offering customized actuation performance (e.g., by customizing the motor unit housing and/or transmission module used by a joint assembly), the sensing capabilities (e.g., customizing the sensor module), the user interface (e.g., LED output provided through an end cap or other component), and/or other aspects. The system preferably includes a plurality of each component so that multi-axis robot configurations can be assembled.

FIG. 2 illustrates an embodiment of a joint assembly 200. Transmission module 202 shows a front view of a transmission module. Transmission module 204 shows a side view of a transmission module. Motor unit housing 208 shows a front view of a motor unit housing. Motor unit housing 210 shows a side view of a motor unit housing. Sensor module 206 shows a front view of a sensor module. Sensor module 212 shows a side view of a sensor module.

FIG. 3 illustrates an alternative embodiment of a joint assembly 300. The joint assembly houses a motor unit housing 306, a universal connector 308, a transmission module 310, a universal connector 312, a sensor module 314, a universal connector 316, an end cap 318, and electronics.

A joint assembly can include a variety of combinations of sub components. A joint assembly of a preferred embodiment can include a first joint engagement that is integrally attached to a motor unit housing, a transmission module, and a second joint engagement that is integrally attached to a sensor module. In one variation, the sensor module is positioned adjacent to the transmission module, opposite the motor unit housing.

In a first variation, the first joint engagement can be integrally attached to the sensor module, the motor unit housing, and the second joint engagement can be integrally attached to the transmission module with the sensor module positioned adjacent to the motor unit housing and opposite the transmission module. The sensor module and the motor unit housing are preferably rotatably positioned to the second joint engagement through the transmission module.

In a second variation of the joint assembly, the first joint engagement can be integrally attached to the sensor module, and the second joint engagement can be integrally attached to the motor unit housing. In this second variation, the sensor module can be positioned adjacent to the motor unit housing and rotatably positioned to the second joint engagement by way of the motor unit housing.

In some variations, the joint assembly is attached to an external motor unit housing, sensor module, or a transmission module. Preferably, the joint assembly includes the motor unit housing, the sensor module, and/or the transmission module as integrated components of the joint assembly.

A motor unit housing of a preferred embodiment functions to include a motor or other suitable driving element. The motor can include any suitable type of motor. The motor unit housing can include a first motor unit housing that is interchangeably positioned within the joint assembly with a second motor unit housing. In one variation, the motor unit housing enables a user to manually mount a selected motor to the motor unit housing. This can enable a wide variety of motor options. In another variation, there may be a variety of motor unit housings, where each variety of motor unit housing has a particular motor type. In this variation, the motor type can be customized by selecting different motor unit housings. The motor unit housing preferably includes an electrical interface to the power and communication lines. Gearboxes and/or motor driver circuitry or electronics may be integrated directly into the motor unit housing, but may alternatively be integrated in other ways. The motor unit housing can be rotatably positioned to the second joint engagement by way of the transmission module and the sensor module.

A transmission module of a preferred embodiment functions to enable customization of a transmission used within a joint assembly. The transmission module can be interchangeably positioned within the joint assembly with a second transmission module. As in the motor unit housing, a first variation can enable a user to manually mount a selected transmission to the transmission module. In another variation, there may be a variety of transmission modules with differing transmission types and configurations. A user can customize a transmission by selecting a transmission and optionally using multiple transmission modules in combination.

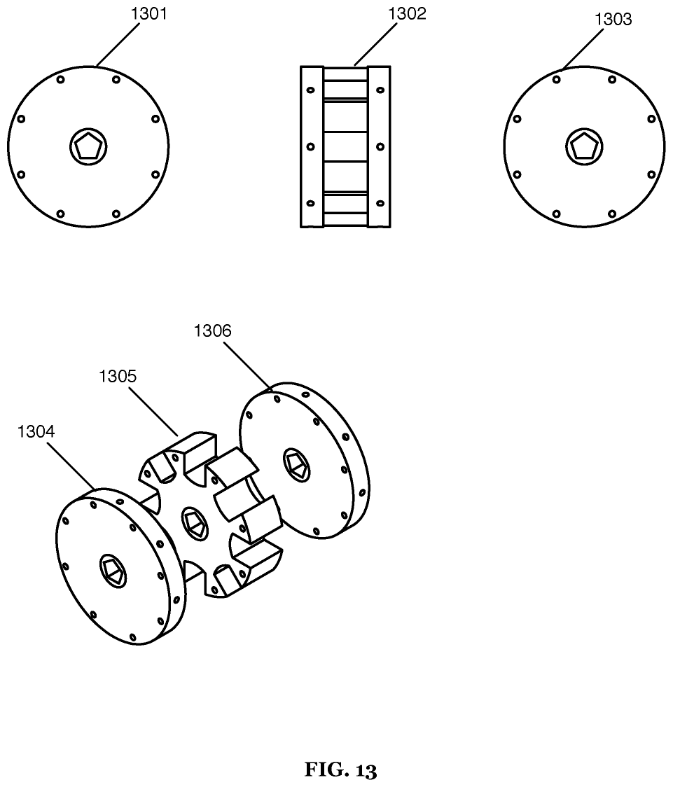

A sensor module is preferably positioned adjacent to the transmission module, opposite the motor unit housing, but any suitable order may be used. A joint assembly may alternatively include a sensor module without a motor module or a transmission, include multiple sensor modules, and/or use any suitable combination of components within one joint assembly. Additionally, a sensor module could be used within a link assembly. As shown in FIG. 13, a sensor module can be composed of multiple components, two end plates 1304 and 1306 and an intermediary holder plate 1305. The end plates are preferably rigidly attached to opposing sides of the intermediary holder plate as shown in the assembled sensor module 1302. The intermediary holder plate can include one or more defined cavities in which a sensor element can be positioned. As shown in the front and back views of the endplates 1301 and 1303, a through shaft can include a driving element to pass through the center of the sensor module. The defined cavities are preferably receptacles for customized electronic components such as sensors. An electrical interface is preferably integrated into the defined cavity such that a connected electronic component is conductively coupled to the power and/or communication lines.

The sensor module (or more generally described as a electronic component module) may additionally or alternatively be used for any suitable electronic component. A sensor element could be any suitable electronic element. The sensor elements are preferably used to collect data from the environment. An electronic component could be a sensor as described, but may alternatively be an output device, user input device, and/or an alternative electronic device. For example, output devices could include a display, an indicator light, a speaker, a haptic feedback device (if the robot configuration is used with human manipulation, a vibrational motor could be used as a form of feedback for the user), or any suitable output device.

Alternative modules could be similarly provided such as an end effector, machine tooling element, slip ring modules, computing modules, bearing modules, encoder modules and the like. Slip ring modules may be used to offer 360 degrees of rotation. Additionally, custom joint assemblies may be used within a robotic configuration. Additionally, a combined module may be a single module that includes components of a motor unit housing, a transmission module, and/or a sensor module as a single component.

Each of the various joint assembly subcomponents can be interchangeable and may even enable internal components such as motors, transmissions, sensors, computing elements, bearings, and/or other elements to be exchanged for greater customization options.

FIG. 4 illustrates an embodiment of link assembly and end cap 400. Link assembly 408 is a side view of a link assembly. Link assembly 410 is a front view of a link assembly. End cap 402 shows a front view of an end cap. End cap 404 shows a back view of an end cap. End cap 406 shows a side view of an end cap.

A link assembly functions as a structural element and conduit for power and communication lines. A link assembly can include a first link engagement structure oppositionally positioned to a second link engagement structure across a structural enclosure with communication links and power connectors integrally coupled within the structural enclosure. A link engagement structure is a section of the link assembly that can connect to a component such as a joint assembly, a universal connector, or another link assembly.

An end cap functions to seal off openings in a robotic configuration such as at the end of a joint assembly, a link assembly, or a universal connector. An end cap preferably includes a coupling engagement surface and protective covering.

A joint assembly, a link assembly, an end cap and any suitable component in the modular robotic system may all be connected through a combination of universal connectors. Preferably a set of basic universal connectors is used for adjacent, coaxial alignment and multi-sleeved universal connectors are used for universal connectors offering a translation (rotational and/or displacement) between at least two sets of components.

A universal connector preferably includes at least one engagement structure (i.e., a sleeve) with at least two engagement regions. The engagement structure is preferably a ring or sleeve with engagement regions on opposing sides. Herein, a ring is shown as the preferred sleeve profile but the sleeve engagement structure may alternatively have any suitable sleeve profile such as a rectangle, pentagon, hexagon, or any suitable profile that conforms and promotes coupling of other components. In one implementation, the universal connector can include a sleeve with a first circumferential engagement region that is positioned opposite to a second circumferential engagement region on an interior engagement surface within the universal connector. In one variation, a sleeve of the universal connector can have a first circumferential engagement region that is positioned opposite to a second circumferential engagement region on an interior engagement surface within the universal connector. The sleeve can additionally be angularly positioned across a bracket to a second sleeve of the same or different configuration. In a basic universal connector, a single sleeve enables two components to be coaxially mounted on opposing sides of the basic universal connector. In an angled universal connector, two sleeves can be used to mount components at various orientations. The angled universal connector is preferably used to translate the angular orientation but may additionally or alternatively be used to provide displacement. For example, a universal connector with a U-shaped bracket may provide a displacement of two components while keeping their central axes parallel. Up to four components may be mounted to a two-sleeved universal connector. In one variation, at least one sleeve may only have a single engagement region. Alternative bracket structures may support greater than two sleeves.

FIG. 5 is an embodiment of a universal connector 500. The system preferably comprises a plurality of universal connectors with at least two engagement surfaces (e.g., sleeves) with at least two engagement regions (e.g., a first and second portion of one or more sleeves that can be coupled to another component). The upper figure shows a side view of a universal connector 500 illustrating sleeves 502 and bracket 512, and a front view illustrating engagement surface 510. The lower portion illustrates the engagement surface 504, another embodiment off universal connector 500 with engagement surface 506 and sleeve 508.

The system can additionally include a base module that functions as a terminating component of the robotic configuration. The base module can be mounted or fixed to a surface such as a floor or other structure. The base module can additionally house various components used in powering and communicating with the system. The base module could include user interface elements or other suitable control mechanisms. The base module can additionally include communication module to communicate over a wired or wireless connection. The system can additionally include multiple base modules. For example, a delta robotic configuration may include three base modules that provide three static mounting points. A base module may additionally be actuated. For example, the base module may provide one or two-dimensional actuation.

The system can be used in a variety of configurations. The described robotic configurations are only a limited sample of examples and is not intended to limit the robotic configurations that can be achieved from the system. The system can preferably operate in various modes depending on the robotic configuration. Some robotic configurations can include additional components such as linear actuators or other robotic or electromechanical systems.

FIG. 6 is an embodiment of a six-axis configuration modular system for constructing robots 600. This embodiment shows motor unit housing 602, link assembly 604, universal connector 606, end cap 608, and motor unit housing 610, showing a possible different configurations of joint assemblies.

FIG. 7 is an embodiment of a seven axis redundant robot 700. Modular system 702 shows a configuration to accomplish similar tasks as static robotic system 704.

FIG. 8 illustrates an embodiment of a six-axis robot and SCARA (i.e., Selective Compliance Assembly Robot Arm) robot 800. Modular six-axis system 802 shows a configuration to accomplish similar tasks as static six-axis system 808. Modular SCARA system 804 shows a configuration to accomplish similar tasks as static SCARA system 806.

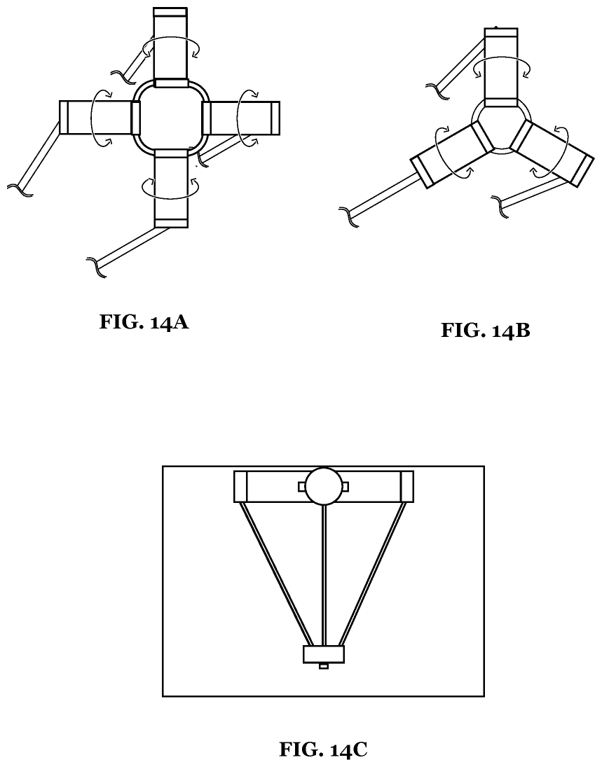

As shown in FIGS. 14A-14C, the system may be assembled into a delta robot configuration. In this robotic configuration variation, there may be multiple fixed base modules. Assemblies can be arranged along a perimeter with arms that extend to an end effector that can be manipulated by cooperative actuation of the various assemblies as shown in FIG. 14C. Various numbers of arms may be used in creating a delta robot formation. For example, a four arm variation as shown in FIG. 14A or a three arm variation as shown in FIG. 14B may be used.

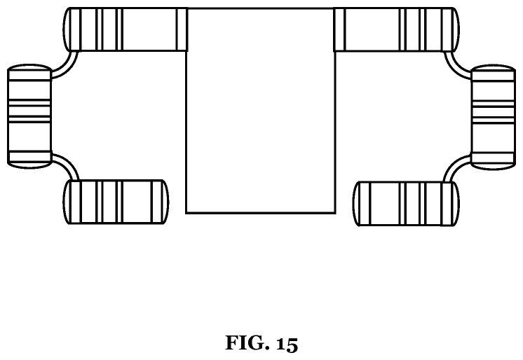

As shown in FIG. 15, the system may be assembled into a multi-arm robotic configuration. This may be used in creating a multi-armed robot.

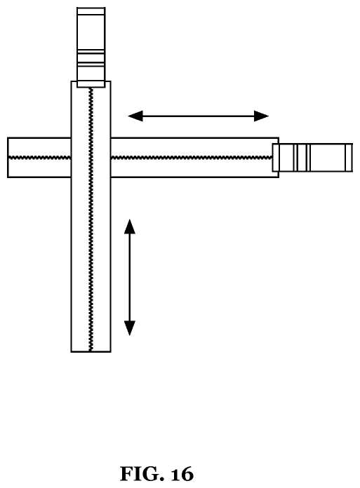

The system may be assembled into a Cartesian plane robot. The system can include or be integrated with linear actuators. Sub-assemblies of the modular system components can be configured to control and drive linear actuators in a particular fashion. As shown in FIG. 16, two linear actuator systems could be used wherein each linear actuator system is driven by a configured sub-assembly.

### 3. Method

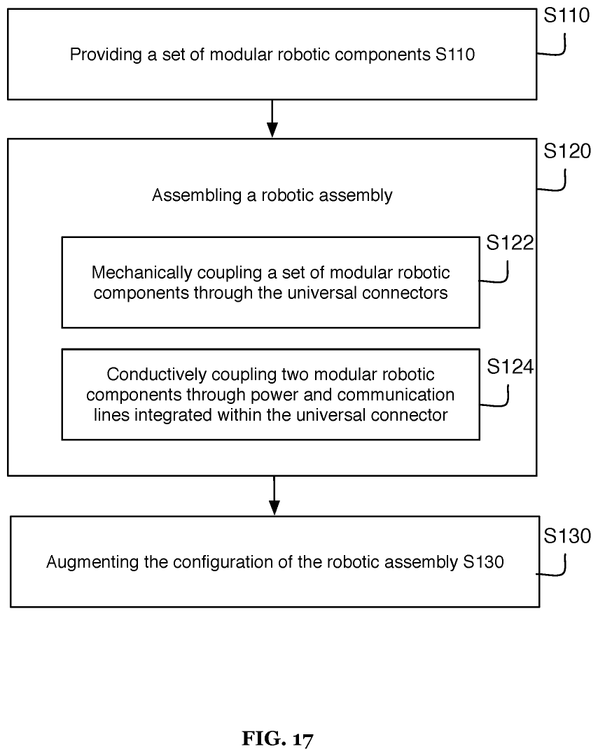

As shown in FIG. 17, a method for constructing a robot of a preferred embodiment can include providing a set of modular robotic components S110, assembling a robotic assembly S120 comprising mechanically coupling a set of modular robotic components through the universal connectors S122 and conductively coupling two modular robotic components through power and communication lines integrated within the universal connector S124; and augmenting the configuration of the robotic assembly S130.

Block S110, which includes providing a set of modular robotic components functions to offer a variety of modular robotic components. The set of modular robotic components are preferably the set of robotic components described above, but any suitable modular robotic components may additionally be included. The set of modular robotic components can include: universal connectors; link assemblies; end caps; and motor unit housings, transmission modules, and sensor modules used within joint assemblies. The modular robotic components may additionally include end effectors, base modules, and/or other alternative robotic modules. As described in the system above, the robotic components can be used interchangeably to assemble various robotic configurations. A given robotic configuration will generally use multiple instances of the robotic components. Also, a given robotic configuration may only use a subset of the possible types of robotic configurations. For example, a first robotic configuration may not include a sensor module, and a second robotic configuration may not include a transmission module.

Block S120, which includes assembling a robotic assembly, functions to use the robotic components to build a robotic configuration. Robotic modules can preferably be used interchangeably to form different configurations. The selection and arrangement can alter the kinematic properties of a robotic configuration and operating performance. The robotic module components preferably include integrated power and communication lines such that through mechanical assembly conductive coupling is simultaneously established. Accordingly, assembling the robotic assembly can include mechanically coupling a set of modular robotic components through the universal connectors 5122 and conductively coupling two modular robotic components through power and communication lines integrated within the universal connector S124.

Block S122, which includes mechanically coupling a set of modular robotic components through the universal connectors, functions to attach the various components together. Assembling a joint assembly can be one substep of mechanically coupling a set of modular robotic components. A joint assembly provides an actuating link between components and can include a motor unit housing, a transmission module, a sensor module, and/or link assemblies. The various components are preferably connected through basic universal connector sleeves as shown in FIG. 3. The selection of the variety of components and the arrangement of components are two variables that can be augmented to customize the performance properties of joint assembly. Coupling two robotic components through a universal connector is another subset in assembling a robotic configuration. The universal connector is preferably used to mechanically couple two joint assemblies or link assemblies of any suitable combination. A joint assembly and/or link assembly can preferably be connected to one or two universal connectors. In one variation, coupling two robotic components through a universal connector can include selecting an angled universal connector. There may be multiple options of angled universal connectors. Such as a forty-five degree angled universal connector and a ninety-degree angled universal connector. There may also be a variable angle universal connector. In one variation, the selection of an angled universal connector may include selecting a connecting bracket used in assembling a universal connector. The various modular components include engagement surfaces used in connecting to universal connectors. Sealing exposed engagement surfaces can be an additional substep. An end cap is preferably used to seal an exposed engagement surface.

Block S124, which includes conductively coupling two modular robotic components through power and communication lines integrated within the universal connector, functions to establish electrical connections through out the robotic configuration. Each modular component preferably includes integrated power and communication lines and electrical interfaces. The electrical interfaces are preferably configured to engage with a connected modular component when mechanically coupled. For example, a joint assembly will have a connected path of power and communication lines extending from a first and second engagement regions, with the power and communications extending across the intermediary motor unit housing, sensor module, transmission module and/or basic universal connectors. Similarly, the power and communication lines are bridged across a universal connector between two modular components.

Once assembled, the robotic assembly can be used for its particular task. At a later point when the robot needs to be altered, block S130 may be initiated.

Block S130, which includes augmenting the configuration of the robotic assembly, functions to leverage the modularity of the modular components to change or alter the kinematic or performance properties of the robotic configuration. In one variation, augmenting the configuration of the robotic assembly can include altering the performance properties of a joint assembly. Altering the performance properties can include exchanging the motor unit housing and/or transmission. For example, a first type of motor unit housing may be exchanged for a second type of motor unit housing, wherein the first and second motor unit housings have different motor types. Augmenting the configuration can additionally include altering an electronic component integrated into a sensor module. Augmenting the configuration of the robotic assembly can also include reconfiguring modular components of the robotic assembly, which may include adding, removing, and/or rearranging modular components Reconfiguring may be applied to change the robotic configurations between a SCARA robot configuration, a multi-axis configuration, a multi-arm configuration, a delta robotic configuration, and/or any suitable configuration.

As a person skilled in the art will recognize from the previous detailed description and from the figures and claims, modifications and changes can be made to the embodiments of the invention without departing from the scope of this invention as defined in the following claims.

We claim:

1. A modular system comprising:
a set of modular robotic components comprising:
a set of universal connectors, each universal connector comprising at least one sleeve with at least two engagement regions;
at least one joint assembly comprising an interchangeable set of subcomponents that comprise at least a sensor module, a motor unit housing, or a transmission module, wherein the joint assembly comprises a first and a second joint engagement region that can couple to an engagement region of one of the set of universal connectors;
wherein the joint assembly and the set of universal connectors each comprise integrated power and communication lines with connection interfaces that conductively couple between connected robotic components; and
wherein in a first configuration mode, the set of modular robotic components comprise a first arrangement of modular robotic components.

2. The modular system of claim 1, wherein the first configuration mode comprises the set of modular robotic components arranged in a Selective Compliance Assembly Robot Arm configuration.

3. The modular system of claim 1, wherein the first configuration mode comprises the set of modular robotic components arranged in a delta robotic configuration.

4. The modular system of claim 1, wherein the first configuration mode comprises the set of modular robotic components arranged in a multi-axis robotic configuration with at least six joint assemblies and at least five universal connectors.

5. The modular system of claim 1, wherein the first configuration mode comprises the set of modular robotic components arranged in a multi-arm robotic configuration with at one universal connector being connected to at least three modular robotic components.

6. The modular system of claim 1, wherein the first configuration mode comprises a Cartesian plane robotic configuration.

7. The modular system of claim 1, wherein at least a subset of modular robotic components can be reconfigured into a second configuration mode.

8. The modular system of claim 1, wherein the sensor module comprises a set of sensor element receptacles that are conductively coupled to the power and communication lines.

9. The modular system of claim 1, wherein the set of universal connectors further comprise:
a basic universal connector that comprises a single sleeve with engagement regions on opposing sides of the sleeve engagement surface; and
an angled universal connector that comprises a first and second sleeve, wherein the each of the first and second sleeves include two engagement regions; the angled universal connector further comprising a connecting bracket that mechanically couple the first and second sleeve engagement surfaces at an angled alignment;
wherein in the first configuration mode, a first basic universal connector couples two subcomponents of the joint assembly in a coaxial arrangement and a first angled universal connector couples two subcomponents of two different joint assemblies in an angled arrangement.

10. The modular system of claim 8, wherein a basic universal connector is used in mechanically coupling the motor unit housing, the sensor module, and a transmission module within a joint assembly.

11. The modular system of claim 8, wherein the first sleeve engagement surface, the second sleeve engagement surface, and the bracket are distinct parts that can be assembled to form the angled universal bracket.

12. The modular system of claim 1, wherein the motor unit housing includes an interchangeable motor.

13. The modular system of claim 1, wherein the set of modular robotic components further comprises: at least one link assembly comprising a first link engagement region that is positioned opposite to a second link engagement region across a structural enclosure; and a plurality of end caps comprising a cap engagement region and protective covering; wherein the link engagement region and the cap engagement region can couple to an engagement region of one of the set of universal connectors.

14. A method comprising:
providing a set of modular robotic components that comprises universal connectors, link assemblies, and joint assemblies, wherein the joint assemblies further comprise motor unit housings, transmission modules, and sensor modules;
assembling a robotic assembly of a first configuration, which comprises mechanically coupling the set of modular robotic components through the universal connectors and conductively coupling the mechanically coupled modular robotic components through integrated power and communication lines; and
augmenting the configuration of the robotic assembly.

15. The method of claim 14, wherein augmenting the configuration of the robotic assembly comprises altering a sensing element integrated into a sensor module.

16. The method of claim 14, wherein augmenting the configuration of the robotic assembly comprises exchanging a first motor unit housing to a second motor unit housing, wherein the motor unit housing and second motor unit housing include different motor types.

17. The method of claim 14, wherein augmenting the configuration of the robotic assembly comprises exchanging a first transmission of a transmission module to a second transmission of the transmission module.

18. The method of claim 14, wherein augmenting the configuration of the robotic assembly comprises reconfiguring the joint assembly between a first set of components and a second set of components.

19. The method of claim 18, wherein the first set of components is different from the second set of components.

20. The method of claim 14, wherein augmenting the configuration of the robotic assembly further comprises reconfiguring the robotic assembly between a first configuration and at least a second configuration, wherein the first and second configurations have different arrangements of universal connectors, joint assemblies, and link assemblies.

21. The method of 20, wherein the first and second configurations are selected from a set of configurations that include at least a Selective Compliance Assembly Robot Arm configuration, a delta robotic configuration, a multi-axis robotic configuration, and a multi-arm robotic configuration.
